(19) United States
(12) Patent Application Publication
(10) Pub. No.: US 2014/0239725 A1
(43) Pub. Date: Aug. 28, 2014

(54) MAXIMIZING POWER OUTPUT OF SOLAR PANEL ARRAYS

(71) Applicant: INNOREL SYSTEMS PRIVATE LIMITED, Bangalore (IN)

(72) Inventors: Prakash Easwaran, Bangalore (IN); Rupak Ghayal, Bangalore (IN); Saumitra Singh, Bangalore (IN)

(73) Assignee: INNOREL SYSTEMS PRIVATE LIMITED, Bangalore (IN)

(21) Appl. No.: 13/773,667

(22) Filed: Feb. 22, 2013

(51) Int. Cl. H02J 1/00

(52) U.S. Cl. CPC H02J 1/00
USPC 307/77

(57) ABSTRACT

A system for generating electric power includes a first DC source, a second DC source and a shared optimizer. The first DC source provides a first voltage across a first node and a second node, while the second DC source provides a second voltage across the second node and a third node. The shared optimizer is designed to provide a first programmable current source between the first node and the second node as well as a second programmable current source between the second node and the third node. In an embodiment, the first and second DC sources are solar panels, and the optimizer includes a DC-DC converter, which operates to maximize power output of the solar panels. The use of a single (shared) optimizer may obviate the need for separate optimizers for each solar panel, and thereby reduce system cost.

### RELATED APPLICATIONS

The present application is related to co-pending US Patent Application entitled, “HARVESTING POWER FROM DC (DIRECT CURRENT) SOURCES”, Publication Number: US 2012-0193986A1: attorney docket number: COSM-001, Filed: 25 Mar. 2011, which is incorporated in its entirety herewith.

### BACKGROUND

1. Technical Field

Embodiments of the present disclosure relate generally to green technologies, and more specifically to techniques for maximizing power output of solar panel arrays.

2. Related Art

A solar panel refers to a packaged assembly of photovoltaic cells, with each cell generally being designed to generate power from incident solar energy in the form of light. A single solar panel generally produces only a limited amount of power. Hence, several solar panels are typically combined to form a solar panel array. Solar panels may be combined in series to generate a higher voltage output. Multiple series-connected solar panels may also be combined in parallel to enable a higher output current capability.

It is generally desirable to maximize the power output of solar panels such that increased power is available for use by external systems.

### BRIEF DESCRIPTION OF THE VIEWS OF DRAWINGS

Example embodiments will be described with reference to the accompanying drawings briefly described below.

FIG. 1 is a block diagram of a prior power generation system that uses solar panel arrays.

FIG. 2 is a diagram illustrating a set of V-I curves of some solar panels.

FIG. 3 is a block diagram illustrating the manner in which panels in a solar panel array are controlled by an optimizer to maximize power output, in an embodiment of the present invention.

FIG. 4 is a diagram illustrating partial internal details of an optimizer in an embodiment.

FIG. 5A is a diagram illustrating control intervals in which an optimizer performs operations to cause the generation and connection of a corresponding programmable current source to a corresponding panel of a solar panel array, in an embodiment.

FIG. 5B is a timing diagram illustrating some of the operations in a control interval, in an embodiment.

FIG. 5C is another timing diagram illustrating some of the operations in a control interval, in an embodiment.

FIG. 5D is a timing diagram illustrating waveforms of primary and secondary currents in a transformer of a flyback converter, in another embodiment.

FIG. 6A is a flowchart illustrating the manner in which determination is made of the magnitude of programmable current source to be provided across a panel.

FIG. 6B is an example graph showing the variations in power (P) generated by a panel with respect to current through the panel.

FIG. 7 is a diagram illustrating partial internal details of an optimizer in an alternative embodiment of the present invention.

FIG. 8 is a diagram showing partial implementation details of an optimizer in another embodiment of the present invention.

FIG. 9 is a flowchart illustrating the manner in which an optimizer maximizes the power output of a string of solar panels as a whole, in an embodiment.

FIG. 10 is a diagram illustrating the term duty cycle used in a flyback converter of an optimizer, in an embodiment.

FIG. 11A is an example set of current-to-voltage curves of a panel, for various levels of insolation.

FIG. 11B is an example set of power -to-voltage curves of a panel, for various levels of insolation.

FIG. 11C is an example set of power-to-current curves of a panel, for various levels of insolation.

FIGS. 12A, 12B, 12C and 12D are diagrams depicting respective states of panels during the operation of an algorithm designed to maximize power output of panels, in an embodiment.

FIG. 13 is a diagram showing multiple panels connected in parallel, and the use of voltage sources to maximize power output of the panels, in an embodiment.

FIG. 14 is a diagram illustrating the manner in which optimization can be provided for more panels than that supported by a single optimizer, in an embodiment.

FIG. 15A is a diagram illustrating the manner in which input terminals of multiple optimizers are connected, in an embodiment.

FIG. 15B is a diagram illustrating the manner in which input terminals of multiple optimizers are connected, in another embodiment.

FIG. 15C is a diagram illustrating the manner in which some drawbacks of the topology of FIG. 15B are overcome, in an embodiment.

FIG. 16 is a diagram illustrating the manner in which operation at peak power points of panels is ensured when the corresponding optimizers have at least one input terminal not connected to either the top or bottom of a series of panels.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

According to an aspect of the present invention, a system for generating electric power includes a first set and a second set of photo-voltaic cells, and a shared optimizer. The first set of photovoltaic cells is provided in a first panel, and is designed to provide a first voltage across a first node and a second node in response to incidence of light. The second set of photo-voltaic cells is provided in a second panel, and is designed to provide a second voltage across the second node and a third node, also in response to incidence of light. The shared optimizer (‘current source’ optimizer) is designed to provide a first programmable current source across the first node and the second node, as well as a second programmable current source between the second node and the third node. Each of the first and second current sources generates a corresponding programmable current to cause the first panel and the second panel to operate at their respective maximum power point (MPP).

In an embodiment, the shared optimizer is coupled to output terminals of the first panel via a first switch, and to the output terminals of the second panel via a second switch. The shared optimizer operates the first and second switches to control the magnitudes of the currents in the first programmable current source and the second programmable current source. In an embodiment, the shared optimizer includes a flyback converter to control and generate the first and second programmable current sources.

In an alternative embodiment, the shared optimizer is directly connected (rather than via switches) to the outputs of the first and second panels. The shared optimizer includes a flyback converter, and is designed to maximize the power output of the series string formed by the first and second panels as a whole, rather than to optimize each panel individually.

According to another aspect of the present invention, the system includes a third panel and a fourth panel, respectively containing a third set of photo-voltaic cells and a fourth set of photovoltaic cells. The outputs of the third panel and the fourth panel are connected in series. A first programmable voltage source is connected in series with the third panel and the fourth panel. A second programmable voltage source is connected in series with the first and second panels. The series combination of the first voltage source, the first panel and the second panel is connected in parallel to the series combination of the second programmable voltage source, the third panel and the fourth panel between the first node and the third node. The first programmable voltage source and the second programmable voltage source are also provided by the shared optimizer The shared optimizer controls the first programmable voltage source and the second programmable voltage source so that each of the first panel, second panel, third panel and the fourth panel operate at their respective maximum power points.

Several features of the present invention will be clearer in comparison with some prior techniques for maximizing the power output of solar panel arrays, and the corresponding prior approaches are first described below.

2. Solar Panel Array

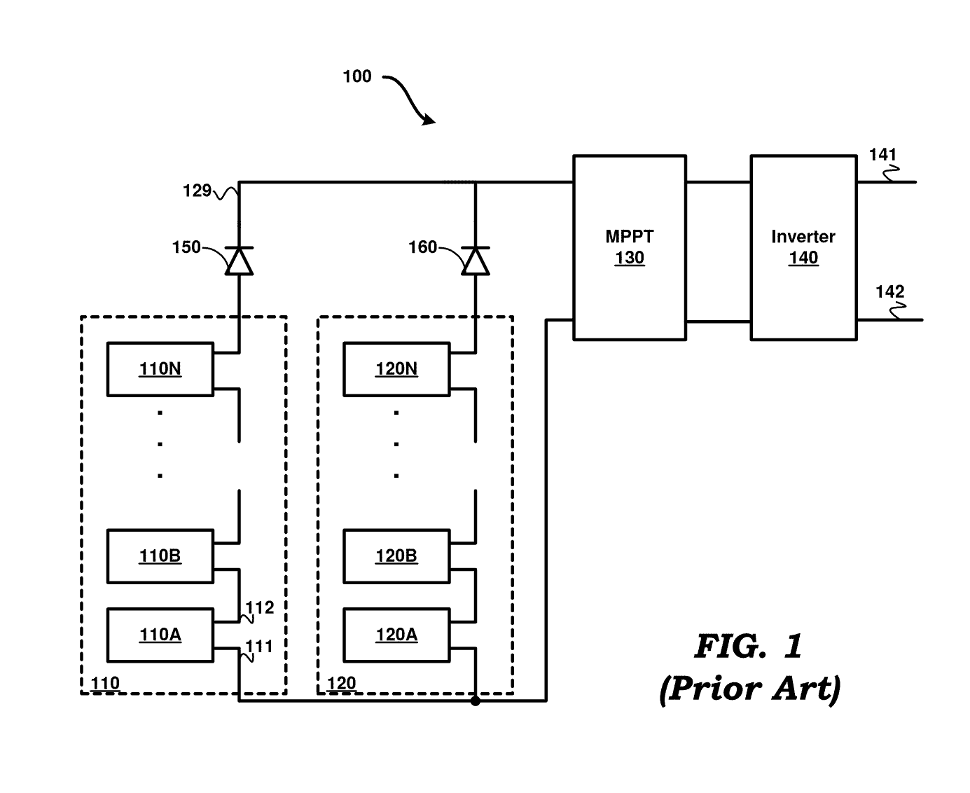

FIG. 1 is a block diagram of a prior power generation system that uses solar panel arrays. System 100 is shown containing solar panels 110A through 110N, 120A through 120N, diodes 150 and 160, maximum power point tracker (MPPT) 130 and inverter 140.

Panels 110A through 110N and 120A through 120N together represent a solar panel array. Each of the solar panels internally contains multiple photovoltaic cells connected to generate electric power in response to incident light. Thus, panel 110A generates an output voltage across terminals 111 and 112. Each of the other panels similarly generates an output voltage across the respective output terminals.

The output voltage generated by a panel is typically small (of the order of a few tens of volts), and therefore multiple panels may be connected in series to obtain a higher output voltage from the combination. In system 100, panels 110A through 110N (collectively referred to as string 110) are shown connected in series, and the resultant output voltage across terminals 129 and 111 is generally the sum of the output voltages of the individual panels 110A through 110N (or of panels 120A through 120N). Panels 120A through 120N are similarly shown connected in series, and collectively referred to as string 120.

The current that may be drawn from a single panel also being typically small, multiple series-connected solar panels may be connected in parallel to obtain a higher current. In system 100, strings 110 and 120 are shown connected in parallel.

Diodes 150 and 160 are respectively provided to prevent a reverse current from flowing through the panels. MPPT 130 is implemented to determine an optimum power point of operation for the solar panels, and to maintain the operation of the panels at an optimum power point. Inverter 140 converts the DC power output of the solar panel array into AC power, which is provided across terminals 141 and 142. Although not shown, the AC power may be distributed to consumers directly, or via a power distribution grid.

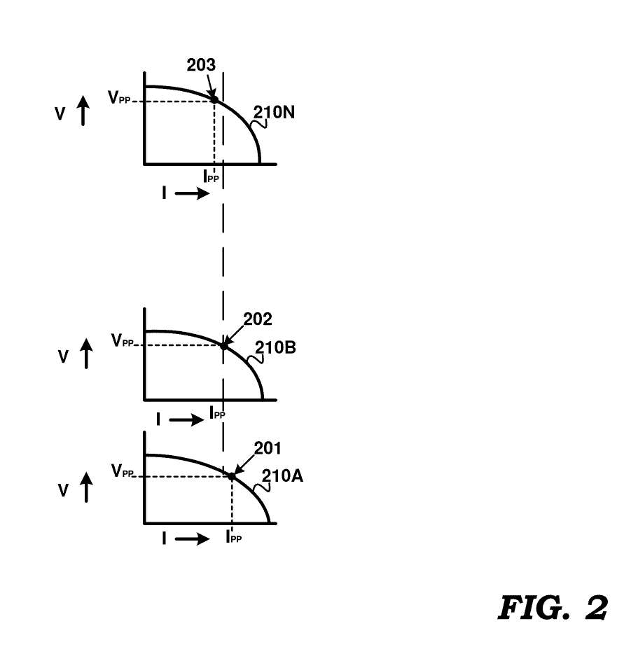

A solar panel is typically associated with a maximum power point. The maximum power point (MPP) is an operating point of a solar panel at which maximum power is drawn from the panel, and corresponds to a voltage and current on a voltage-to-current (V-I) curve of the panel. FIG. 2 shows a set of V-I curves of some of the solar panels in system 100. Curves 210A, 210B and 210N respectively represent the V-I characteristics (well known in the relevant arts) of panels 110A, 110B and 110N. The voltage and current axes of the three curves are assumed to be represented on a same scale. The respective maximum power points (product of voltage and current) of each of the three panels are denoted by points 201, 202 and 203 in the corresponding V-I curve. The voltage and current of each panel corresponding to the MPP (maximum power point) is denoted as Vpp and Ipp respectively, and may be different from panel to panel. Vpp and Ipp are used herein to refer generically to the voltage and current respectively corresponding to the MPP of a panel, and may be referred as the ‘peak voltage’ and ‘peak current’ of the panel.

It may be observed from FIG. 2 that the MPPs of solar panels 110A, 110B and 110N are not all the same. The differences (or mismatch) in the MPPs may arise due to several reasons. Some of the reasons include mismatch arising from manufacturing tolerances, different levels of incident light energy on the solar panels (i.e., different insolation), etc. In general, the MPPs of all the solar panels in panels 110 may not all be the same. Similarly, the MPPs of all the solar panels in string 120 may not all be the same. However, the current flowing through each of the solar panels in string 110 needs to have a same magnitude since the panels are connected in series. As a result, one or more of the panels in string 110 may be operational at a power point different from the corresponding MPP. Similarly, one or more of panels in string 120 may also be operational at a power point different from the corresponding MPP. Such operation is not generally desirable.

Strings 110 and 120 being connected in parallel, the sum of the voltage outputs of strings 110 and 120 is constrained to be equal. Again, any mismatch between the panels results in one or more of the panels not operating at its MPP. In general, the arrangement of multiple solar panels in a serially-connected string often results in one or more of the panels operating away from its MPP. Further, such operation away from MPP may occur even if only a single solar panel is present in a string.

Similarly, a parallel arrangement of multiple solar panels also often results in one or more of the panels operating away from its MPP. MPPT 130, typically is able to set an operating point only for the entire array (all shown strings) as a whole, and one or more panels may still operate at points that are different from the corresponding MPP of the panel.

Another technique described in co-pending US publication number: US 2012-0193986A1, employs an optimizer block/circuit (optimizer) per solar panel to force operation of each of the corresponding panels at the corresponding MPP. With reference to FIG. 1, such a technique employs one (a separate) optimizer across the output terminals of each of panels 110A through 110N. However, the technique may have a drawback in that it employs one optimizer for each solar panel, and therefore may be a relatively expensive solution.

Several features of the present invention address one or more of the disadvantages noted above.

3. Optimizer Architecture

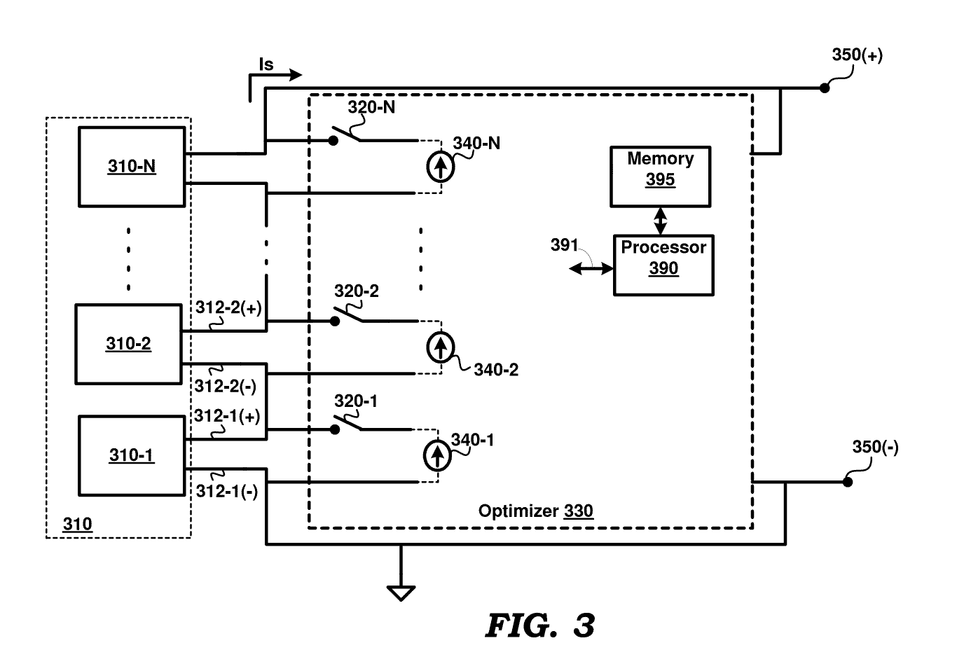

FIG. 3 is a block diagram illustrating the manner in which panels in a solar panel array are controlled by an optimizer to maximize power output, in an embodiment of the present invention. The diagram is shown containing solar panels 310-1 through 310-N, and a single (shared) optimizer 330. Panels 310-1 through 310-N form string 310.

Optimizer 330 is shown containing switches 320-1 through 320-N, programmable current sources 340-1 through 340-N, processor 390 and memory 395. Optimizer 330 may include other circuit blocks, but which are not shown in FIG. 3 in the interest of clarity. Optimizer 330 receives input power for operation from the output of string 310 provided across terminals 350(+) and 350(−). Although not shown in FIG. 3, optimizer 320 generates control signals to operate (open and close) each of switches 320-1 through 320-N. Terminals 350(+) and 350(−) may be connected to inputs terminals of an inverter (not shown) for conversion of the DC output power across 350(+) and 350(−) to AC power. The output of the inverter may be connected to a power distribution network (power grid).

Optimizer 330 operates switches 320-1 through 320-N to be closed and open in a time-division multiplexed (TDM) manner to connect the corresponding programmable current source across the corresponding panel. Thus, switch 320-1 is closed (via a control signal from optimizer 320) for the duration of a first time interval, in which programmable current source 340-1 is connected across the output terminals (312-1(+) and 312-1(−)) of panel 310-1. All other switches (320-2 through 320-N) remain open for the duration of the first interval.

Switch 320-2 is closed for the duration of a second time interval (not overlapping with the first time interval), in which programmable current source 340-2 is connected across the output terminals (312-2(+) and 312-2(−)) of panel 310-2. All other switches remain open during the second interval. The other switches are operated in a similar manner to connect the corresponding programmable current source to the corresponding panel in the corresponding time interval. Although only one switch is noted as being closed in a given time interval (all other switches being open in that time interval), in alternative embodiments of the present invention two or more intervals may overlap.

It may be appreciated from FIG. 3 that a same (single/shared) optimizer is employed to provide more than one programmable current source, with each programmable current source being provided across the output terminals of a corresponding panel.

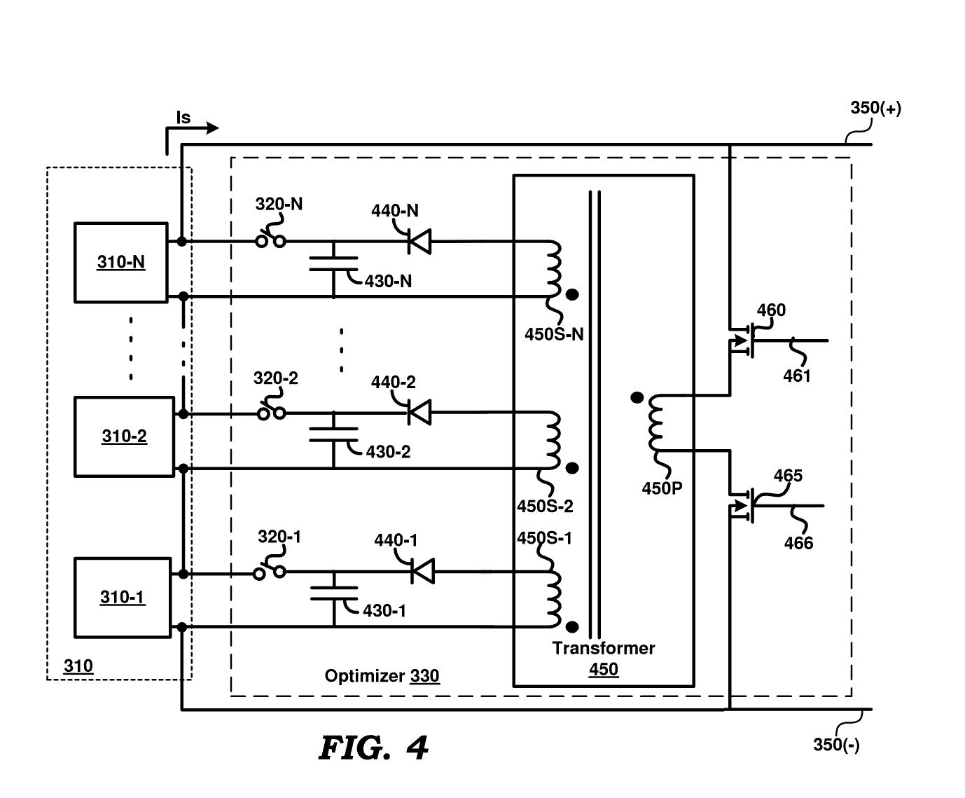

FIG. 4 is a diagram illustrating partial internal details of optimizer 330 in an embodiment. Panels 310-1 through 310-N are also shown. In the embodiment, optimizer 330 is implemented to include a Discontinuous Conduction Mode (DCM) flyback converter, well-known in the relevant arts. The DCM flyback converter is shown in FIG. 4 to include transistor switches 460 and 465, transformer 450, diodes 440-1 through 440-N, and capacitors 430-1 through 430-N. Switches 320-1 through 320-N, processor 390 and memory 395 are also shown included in optimizer 330. Transformer 450 is shown containing primary winding 450P and multiple secondary windings 450S-1 through 450S-N, with the winding sense (direction in which voltage is induced) indicated by the respective dots as shown in FIG. 4. Although two primary switches 460 and 465 are shown in FIG. 4, in other embodiments only a single primary switch may be used. Further, optimizer 330 is described as being implemented as a DCM flyback converter merely as an example. In other embodiments, optimizer 330 may be implemented using other well-known techniques, such as for example, other DC-DC converter topologies or other modes of operation (e.g., continuous conduction mode (CCM) flyback converter), etc. DC-DC converters are well-known in the art and refer generally to circuits which convert a source of direct current (DC) from one voltage level to another.

Primary winding 450P is connected to output terminals 350(+) and 350(−) of string 310 via transistor switches 460 and 465 (primary switches). Each of secondary windings 450S-1 through 450S-N is connectable across the output terminals of respective panels 310-1 through 310-N via respective switches 320-1 through 320-N (secondary switches). The combination of a secondary winding together with the corresponding diode and capacitor represents a programmable current source, the programmability being provided by the operation of optimizer 330 to vary duty cycle of switches, as described below in detail.

Thus, for example, the combination of winding 450S-1, diode 440-1 and capacitor 430-1 represents programmable current source 340-1. Similarly, the combination of winding 450S-2, diode 440-2 and capacitor 430-2 represents programmable current source 340-2, and so on (though alternative implementation of current sources will be apparent to a skilled practitioner). Corresponding circuitry/blocks included in optimizer 330 (for example, processor 390 operating in conjunction with memory 395 and switch drivers (not shown) provide control signals (e.g., via path 391) on path 461 and 466 to control opening and closing of primary switches 460 and 465, as well as on corresponding paths (not shown) for opening and closing of each of switches 320-1 through 320-N.

In an embodiment, the number of turns of all the secondary windings (450S-1 through 450S-N) is the same. However, in other embodiments, the number of turns of at least two of the secondary windings may be different. It is noted here that in such other embodiments, having different number of turns for the secondary windings may be advantageous when the MPPs of respective panels 310-1 through 310-N are different (for example, due to different panels having different number of series-connected cells internally, manufacturing tolerances, etc). As an example, assuming that the panel voltages corresponding to the MPPs of panels 310-1 and 310-2 are in the ratio 1:2, the ratio of turns in secondary 450S-1 to secondary 450S-2 can be selected also to equal the ratio 1:2, thereby simplifying implementation of optimizer 330.

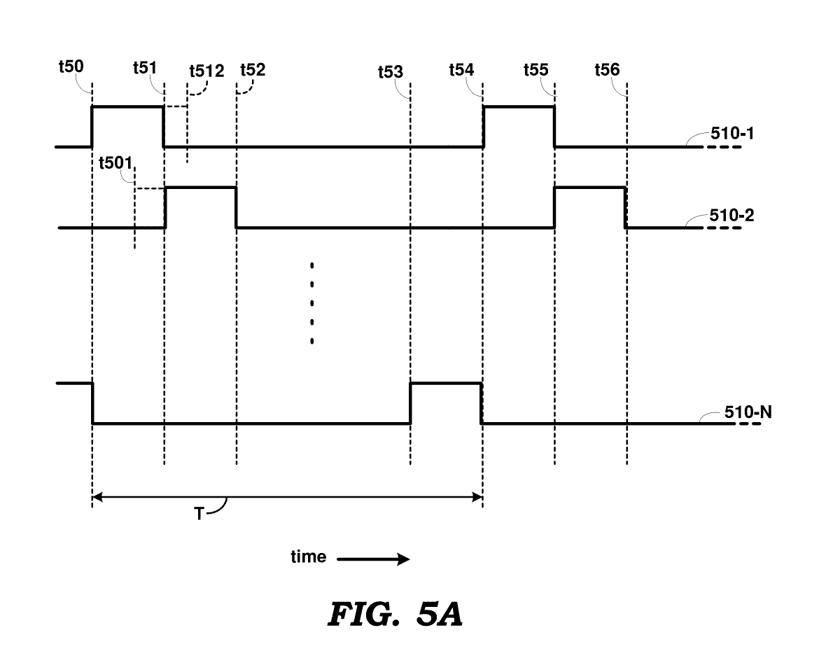

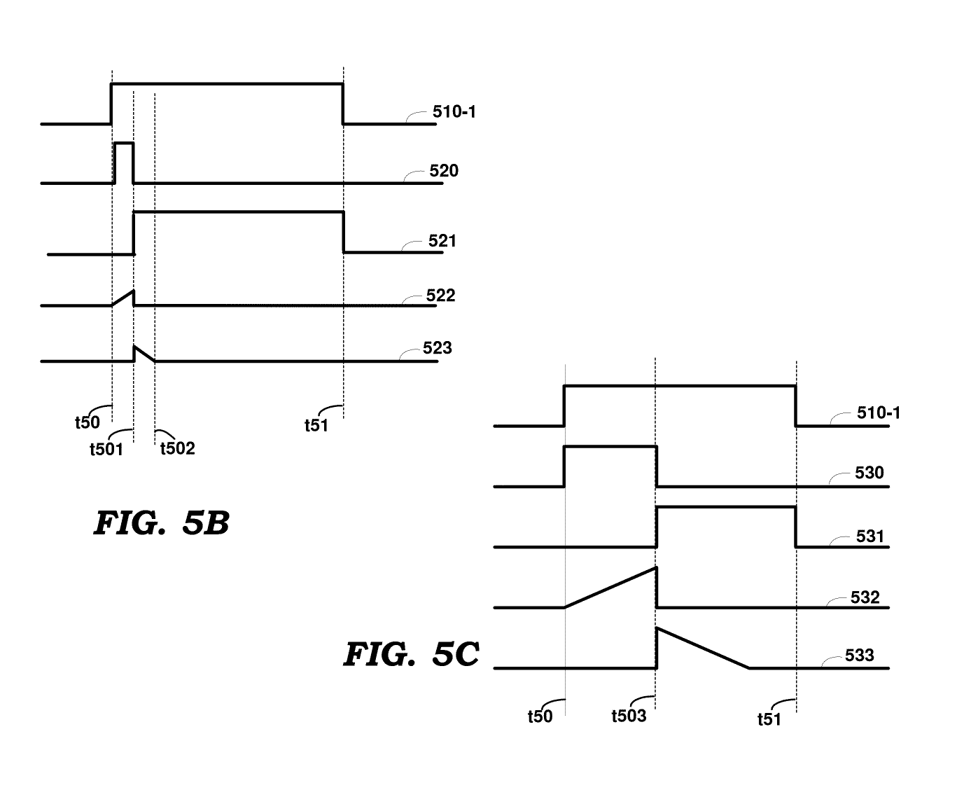

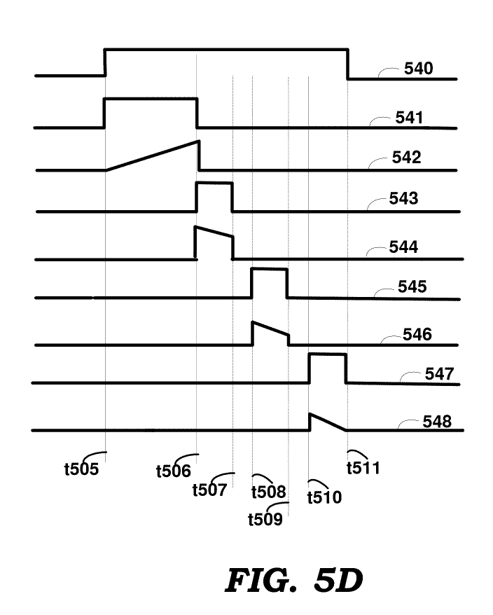

The operation of optimizer 330 in an embodiment is described next with reference to the waveforms of FIGS. 5A, 5B and 5C.

4. Operation

FIG. 5A is a diagram illustrating a sequence of time intervals (termed control intervals), in which optimizer 330 performs operations to cause the generation and connection of a corresponding programmable current source to a corresponding panel. Interval t50-t51 represents a control interval corresponding to panel 310-1, t51-t52 represents a control interval corresponding to panel 310-2, and so on, with interval t53-t54 representing a control interval corresponding to panel 310-N. Starting from time instance t54, the control operations repeat sequentially, with t54-t55 representing another control interval corresponding to panel 310-1, t55-t56 representing another control interval corresponding to panel 310-2, and so on. Thus control intervals corresponding to a particular panel may be non-contiguous. Time period T represents one ‘complete control cycle’, in which operations to generate and connect N programmable current sources occurs once. The control cycles thereafter repeat as also noted above. Time period T may be chosen to allow a wide range of currents for the programmable current sources 340-1 through 340-N to be generated, as well as to minimize the level of ripple in the currents of the programmable current sources. The values of capacitors 430-1 through 430-N may be determined based on the value of T, the total number (N) of panels, etc. It is noted here that although the control intervals are indicated to be non-overlapping in FIG. 5A, in other embodiments, at least two of the control intervals may overlap (with respect to time), with corresponding modifications to the algorithms used to enable operation of the respective panels at their MPPS. To illustrate, a control interval corresponding to panel 310-1 may commence at t50 and end at t512, while a control interval corresponding to panel 310-2 may commence at t501 and end at t52, as shown in FIG. 5A.

In each control interval of FIG. 5A, optimizer 330 controls the durations for which primary switches 460 and 465, and the corresponding ‘secondary switch’ (the corresponding one of switches 320-1 through 320-N) are closed. To illustrate, FIG. 5B depicts the operations performed in control interval t50-t51 corresponding to panel 310-1. Each of primary switches 460 and 465 is closed for a duration t50-t501, as depicted by waveform 520, and current builds up in primary winding 450P, thereby storing energy in transformer 450. As depicted in waveform 520, primary switches 460 and 465 are opened at t501. As depicted in waveform 521, secondary switch 320-1 is closed at t501, and remains closed till end of interval t50-t51 occurring at t51, and the energy stored in the primary winding is transferred to secondary windings in the interval t501-t51. All other switches 320-2 through 320-N may remain open throughout interval t50-t51.

Waveforms 522 and 523 respectively show the currents in the primary winding 450P and secondary winding 450S-1. The current 523 generated in secondary winding 450S-1 is low-pass filtered by the combination of secondary winding 450S-1 and diode 440-1, which together represent a low-pass filter. The operations are repeated cyclically in other corresponding intervals such as t54-t55, and the average value of secondary current (in secondary winding 450S-1), thus generated, represents the desired magnitude of current for programmable current source 340-1 (FIG. 3), thereby enabling panel 310-1 to operate at its maximum power point (MPP).

The durations for which the primary switches and secondary switch 320-1 are closed determine the magnitude of current in secondary winding 450S-1. By varying the durations for which the primary switches and secondary switch 320-1 are closed, a desired average value of secondary current (i.e., magnitude of current provided by programmable current source 340-1, and as generated in the secondary winding 450S-1 as described above) is obtained.

FIG. 5C is a diagram which shows relevant waveforms when a greater magnitude of current in secondary winding 450S-1 than that in FIG. 5B is desired. As shown in FIG. 5C, the primary switches are closed for a longer duration of time (waveform 530) than that shown in FIG. 5B (assuming both the graphs are drawn to equal time scale on X-axis). Secondary switch 450S-1 is closed for a shorter duration of time (waveform 531) than that shown in FIG. 5B. Specifically, t50-t503 is longer than t50-t501 (FIG. 5B), and t503-t51 is shorter than t501-t51. As a result, the magnitudes of primary and secondary currents are greater than that in FIG. 5B.

Waveforms 532 and 533 respectively show the currents in the primary winding 450P and secondary winding 450S-1. Thus, by adjusting/varying the duty cycle (ratio of the ON-duration to (ON+OFF)-duration of each of primary switches 460 and 465 which are operated to open or close simultaneously), a desired magnitude of secondary current, and therefore of programmable current source 340-1, is obtained. Programmable current sources 340-2 through 340-N are similarly provided/generated in other corresponding intervals (e.g., t51-t52 for programmable current source 340-2, t53-t54 for programmable current source 340-N, etc).

In FIGS. 5B and 5C, all the energy stored in transformer 450 resulting from primary current is shown as being transferred to a same secondary winding. In another embodiment, the energy stored in transformer 450 is distributed among multiple secondary windings, as illustrated with respect to FIG. 5D. In FIG. 5D, waveform 541 represents the duration for which switches 460 and 465 are closed, with waveform 542 representing the primary current in transformer 450. The logic high durations of waveforms 543, 545 and 547 respectively represent corresponding durations in which secondary switches 320-1, 320-2 and 320-3 are closed. Waveforms 544, 546 and 548 respectively represent the currents in respective secondary windings 540S-1, 540S-2 and 540S-3 (which correspond respectively to currents of current sources 340-1, 340-2 and 340-3 respectively). In the example above, the energy stored in transformer 450 is shown distributed among three specific secondary windings merely for illustration. In general, such distribution can be among more or fewer numbers of secondary windings.

The specific magnitude of current of a programmable current source to be generated is determined based on the panel voltage and current of the corresponding panel. The current flowing through a panel can be ascertained, for example, by adding a low-valued (sense) resistor in series with the panel, and measuring the voltage drop across the resistor. Optimizer 330 may be designed to contain corresponding measurement circuits (although not shown in the Figures) for measuring panel voltage and panel current, and such circuits are well-known to one skilled in the relevant arts.

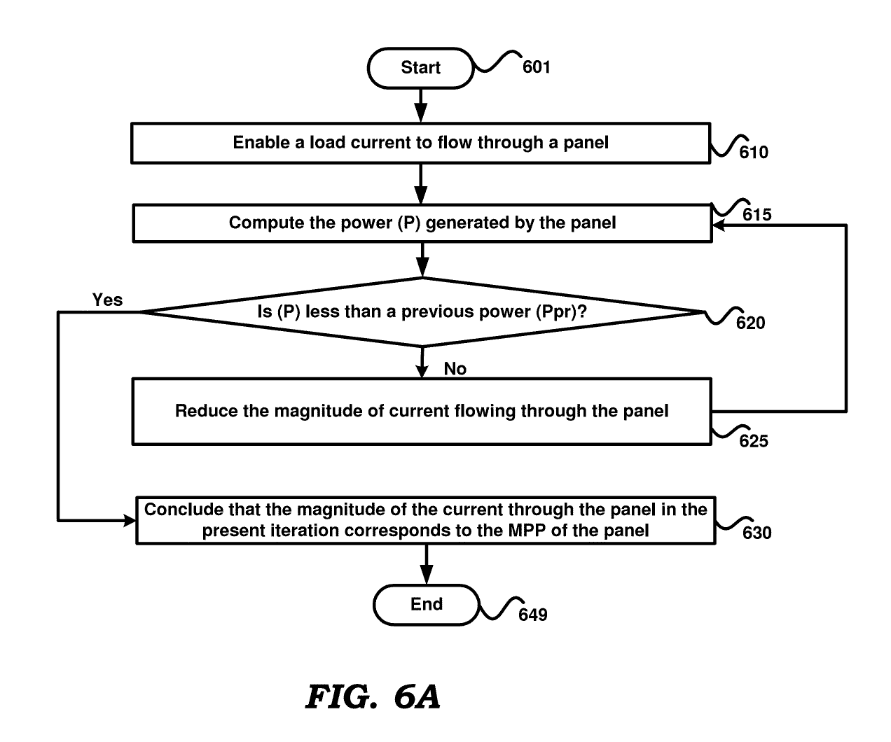

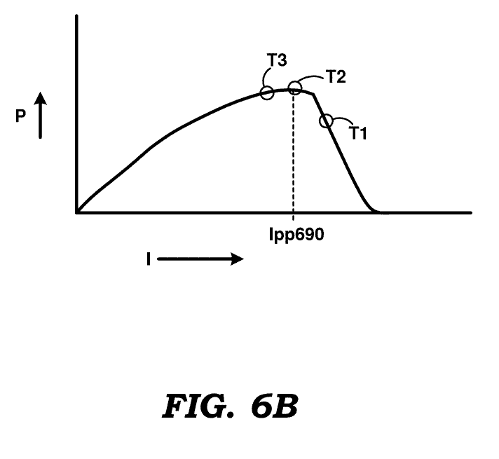

FIG. 6A is a flowchart illustrating an example approach for determining the magnitude of current of a programmable current source to be provided across a panel. The flowchart of FIG. 6A is described with specific reference to panel 310-1. However, the same techniques described with respect to the flowchart of FIG. 6A enable determination of the magnitude of programmable current source to be provided across other panels of FIG. 3 (or FIG. 4) as well. The flowchart starts in step 601, in which control immediately passes to step 610.

In step 610, optimizer 330 enables a string current (Is) to flow through string 310. Optimizer 330 sets the current of programmable current source 340-1 to zero. Control then passes to step 615.

In step 615, optimizer 330 computes the power (P) generated by panel 310-1. The power (P) equals the product of the voltage across panel 310-1 and the current (Is) flowing through panel 310-1. Control then passes to step 620.

In step 620, optimizer 330 determines if the power (P) is less than a power (Ppr) computed in an immediately previous iteration of the steps of the flowchart of FIG. 6A. If (P) is less than (Ppr), control passes to step 630. However, if (P) is greater than (Ppr), control passes to step 625.

In step 625, optimizer 330 reduces the magnitude of current flowing through panel 310-1by increasing the magnitude of current provided by programmable current source 340-1. Control then passes to step 615.

In step 630, optimizer 330 concludes that the current through panel 310-1 in the present iteration is the peak current (Ipp) corresponding to the maximum power point (MPP) of panel 310-1. Control then passes to step 649, in which the flowchart ends.

Processor 390 may retrieve and execute instructions from memory 395 (which contains non-volatile memory portions) to perform the steps of the flowchart of FIG. 6A. Although the flowchart of FIG. 6A is shown as ending in step 649, the steps of the flowchart of FIG. 6A may be performed iteratively at regular intervals. In each of such iterations, the measurement of panel voltage and panel current may be performed just prior to the commencement of the control interval for that panel.

Corresponding to the peak current (Ipp), optimizer 330 measures the peak voltage (Vpp) of panel 310-1 also. Having determined Ipp of panel 310-1, optimizer 330 sets programmable current source 340-1 to generate a current equal to the difference of the string current (Is) and Ipp. As an example, assume that the current through string 310 is 7 Amperes (A), and that each of panels 310-1 through 310-N has a MPP current (peak power point current) of 7A. Now, assuming that the MPP current of panel 310-1 drops to 6A due to shading (reduction in the amount of incident light), then the value of programmable current source 340-1 should be 1 A.

The operations of flowchart of FIG. 6A may be performed ‘on-line’, i.e., with the solar panel array connected to a load, and with a string current being drawn from the solar panel array. Thus, the MPP determination can be performed without having to remove the panels from the array or disconnecting the array from the load. Further, once panel 310-1 reverts back to an operating state in which panel 310-1 receives a higher incidence of light, optimizer 330 may gradually (iteratively, based on measurements of voltage across panel 310-1 and current through panel 310-1) reduce the current through current source 340-1 back to zero, thereby increasing the current flowing through panel 310-1. Thus, the current adjustments of the current through panel 310-1 (reduction of step 625 and the increments/increase noted above) may be performed by optimizer 330 to ensure that panel 310-1 always (or as much as possible) operates at its MPP.

FIG. 6B is an example graph showing the variations in power (P) generated by panel 310-1 with respect to current (I) through panel 310-1. Assume, for illustration, that operating point T1 corresponds to the power (generated by panel 310-1) measured by optimizer 330 when the magnitude of the current provided by programmable current source 340-1 (current 340-1) is 0 A. Optimizer 330 increases current 340-1 to a non-zero value for the next iteration, in which current 340-1 is I1. Assuming that operating point T2 represents the power measured by optimizer 330 for the iteration, it may be observed that the power generated by panel 310-1 corresponding to T2 is greater than that at T1.

In a next iteration, optimizer 330 further increases current 340-1, thereby further reducing the current (Ipanel) through panel 310-1. Assume that T3 represents the power corresponding to the iteration. It may be observed that power corresponding to T3 is lesser than that corresponding to T2. Therefore, optimizer 330 concludes that T2 represents the maximum power point (MPP) of panel 310-1. Ipp690 represents the current at MPP T2, and is thus the peak current Ipp. The voltage corresponding to point T2 is the peak voltage Vpp. Thus, by measuring the power generated by panel 310-1 for various settings of current 340-1, optimizer 330 is able to determine the MPP of panel 310-1. Optimizer 330, thus, obtains the value of the peak current Ipp690 corresponding to the MPP of panel 310-1. With the combined knowledge of Ipp690 and the value of Is, optimizer 330 sets the value of current 340-1 to a value equal to (Is −Ipp690), thereby ensuring that panel 310-1 operates at its MPP. Optimizer 330 determines the value of currents required for the other programmable current sources in a similar manner to that described with respect to FIGS. 6A and 6B.

While the parameter (‘control variable’) that is adjusted to achieve operation of a panel at its MPP is described as being the current through the corresponding current source, in other embodiments optimizer 330 may instead adjust other control variables such as duty cycle (noted above) or panel voltage.

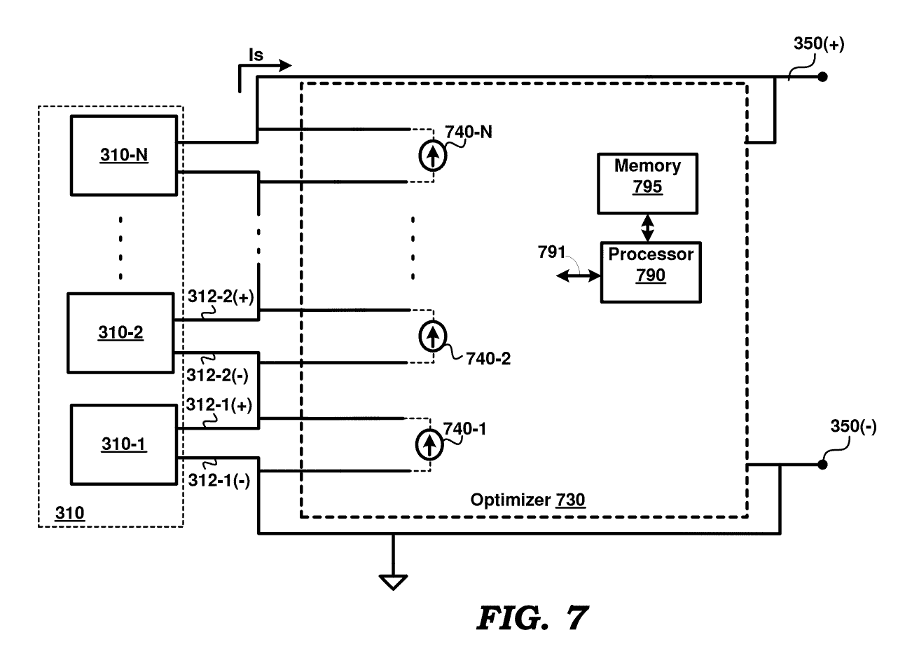

It is noted here that although optimizer 330 of FIGS. 3 and 4 is described as individually (or separately) optimizing the power output of each of panels 310-1 through 310-N (via operation of switches 320-1 through 320-N), in other embodiments, optimizer 330 may instead operate to optimize power output of string 310 as a whole. In such other embodiments, optimizer 330 may measure only the voltage across string 310 (rather than measuring the voltage across each panel), and operate to maximize the power output of string 310 as a whole, as described below with respect to FIG. 7.

The use of switches 320-1 through 320-N may not be desirable at least in some environments for reasons such as, for example, implementation cost, additional wiring or signal routing resources, etc. An alternative embodiment, which does not require the use of any of switches 320-1 through 320-N, is described next.

5. Alternative Embodiment

FIG. 7 is a diagram illustrating partial internal details of an optimizer in an alternative embodiment. Optimizer 730 is shown containing programmable current sources 740-1 through 740-N, processor 790 and memory 795. Memory 795 includes non-volatile memory portions and may additionally include volatile memory. In the embodiment, programmable current sources 740-1 through 740-N are directly connected to the output terminals of respective panels 310-1 through 310-N. In the embodiment, optimizer 730 does not attempt to maximize the power output of each (individual) panels 310-1 through 310-N individually/separately, as in the embodiment of FIG. 3 instead, and as described in detail below, optimizer 730 operates to maximize the power output of string 310 as a whole. Also, optimizer 730 first corrects the ‘most disturbed’ panel (panel that is most away from the other panels in terms of panel voltage corresponding to the MPP, i.e. voltage across the output terminals of the panel).

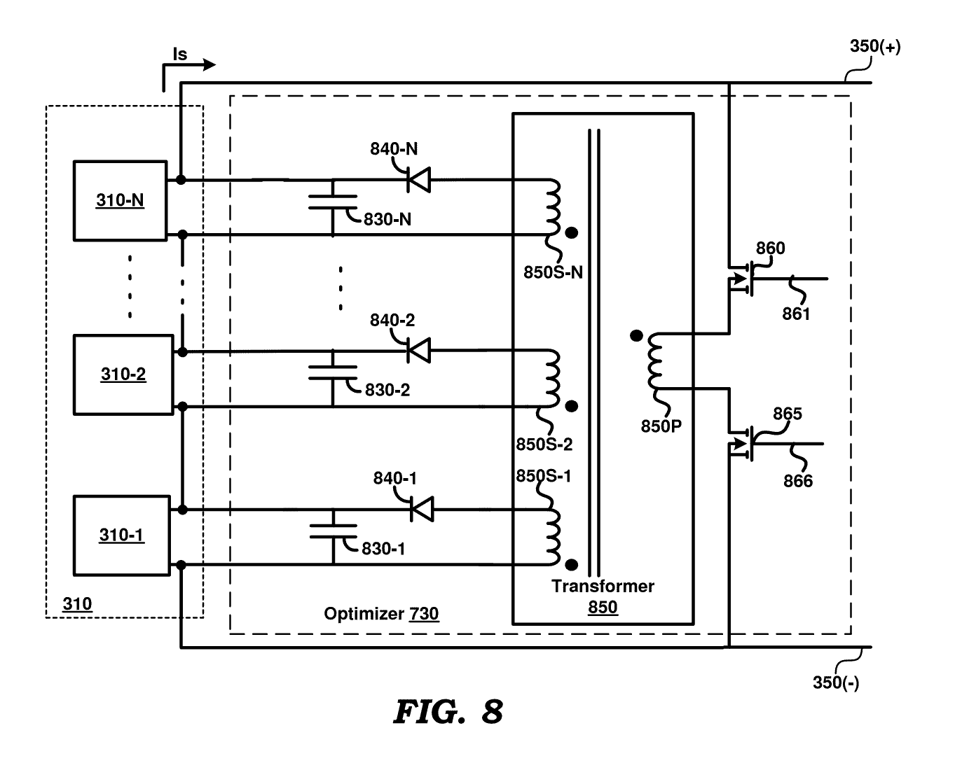

FIG. 8 is a diagram showing implementation details of relevant portions of optimizer 730 in an embodiment. Optimizer 730 is implemented to include a Discontinuous Conduction Mode (DCM) flyback converter, shown in FIG. 8 as formed by transformer 850, primary switches 860 and 865, diodes 840-1 through 840-N, and capacitors 830-1 through 830-N. Transformer 850 is shown containing primary winding 850P, and N secondary windings 850S-1 through 850S-N. Optimizer 730 also includes measurement circuitry for measuring string voltage (voltage across terminals 350(+) and 350(−)), current through string 310 (for example, using a sense resistor in series with string 310, but not shown in the Figures). Processor 790 may generate control signals via path 791, which may be forwarded on respective paths 861 and 866 for closing and opening each of primary switches 860 and 865. Further, while two primary switches 860 and 865 are shown in FIG. 8, in other embodiments only a single switch may be used. When two switches are used, both switches (860 and 865) are together either open or closed. Again, optimizer 730 is described as being implemented as a DCM flyback converter merely as an example. In other embodiments, optimizer 330 may be implemented using other well-known techniques, such as for example other DC-DC converter topologies or other modes of operation (e.g., continuous conduction mode (CCM) flyback converter), etc.

Energy is stored in the transformer 850 in a first phase, and delivered to secondary windings 850S-1 through 850S-N in a next phase. During the first phase, as the primary winding 850P is not connected to the secondary windings, the energy stored is independent of any circuits that may be connected to the secondary windings. In the embodiment, this fact is exploited to enable maximization of the power output of string 310 without having to use any switches (such as 320-1 through 320-N of FIG. 3).

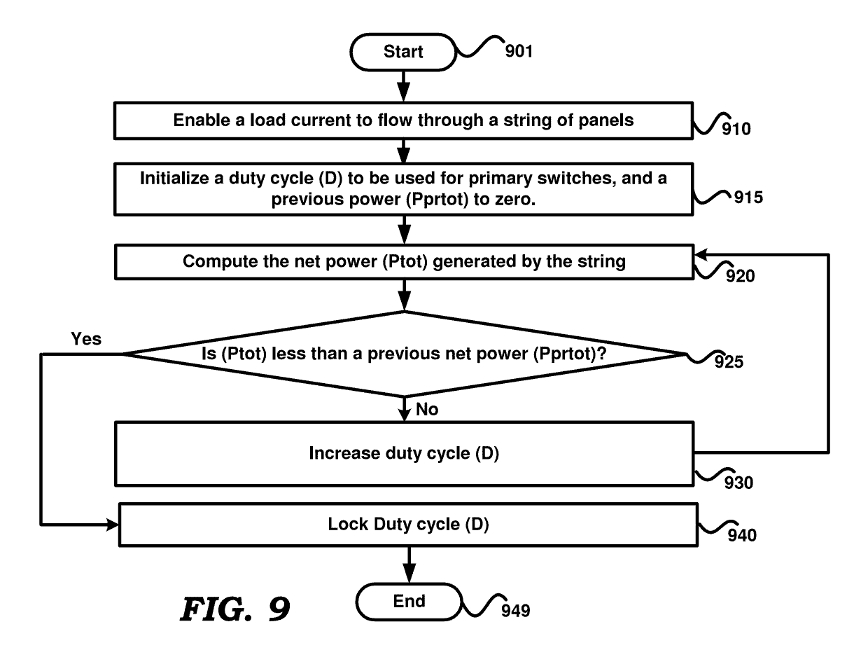

FIG. 9 is a flowchart illustrating the manner in which optimizer 730 maximizes the power output of string 310 as a whole, in an embodiment. The flow chart begins in step 901, in which control immediately passes to step 910.

In step 910, optimizer 730 enables a string current (Is) to flow through string 310. Control then passes to step 915.

In step 915, optimizer 730 initializes the value of a duty cycle (D) to be used for primary switches 860 and 865. In an embodiment, the initialized value of D equals zero. The duty cycle (D) is the ratio of the ON-duration to (ON+OFF)-duration of (each of) primary switches 860 and 865, which are operated to open or close simultaneously. With a Duty cycle D of zero, primary switches 860 and 865 are never closed, and the flyback converter is non-operational. Control then passes to step 920.

In step 920, optimizer 730 computes the net power (Ptot) generated by string 310. The net power generated by string 310 equals the difference between the power generated by string 310 and the power fed to string 310 by optimizer 730. The power fed to string 310 is the power generated in transformer primary winding 850P. The power generated by string 310 equals the product of the output voltage across the terminals 350(+)/350(−) and string current (Is). Optimizer 730 also initializes a “previous” value (Pprtot) of net power to zero. Control then passes to step 925.

In step 925, optimizer 730 checks if the value of Ptot is less than a previous power (Pprtot) corresponding to an immediately previous iteration of the flowchart of FIG. 9. If Ptot is less than Pprtot, control passes to step 940, else control passes to step 930. In step 930, optimizer 730 increases the value of duty cycle (D), and control is then passed to step 920.

In step 940, optimizer 730 locks the current value of duty cycle (D), i.e., optimizer does not further increase (or decrease) the value of the duty cycle. Control then passes to step 949, in which the flowchart ends.

Processor 790 may retrieve and execute instructions from memory 795 to perform the steps of the flowchart of FIG. 9. Although the flowchart of FIG. 9 is noted as ending in step 949, the steps of the flowchart of FIG. 9 may be repeated, for example, at regular intervals. Further, once panel 310-1 reverts back to an operating state that in which panel 310-1 receives a higher incidence of light, optimizer 730 may gradually (iteratively, based on measurements of voltage across panel 310-1 and current through panel 310-1) decrease duty cycle (D), thereby increasing the current flowing through panel 310-1. Thus, optimizer 730 may adjust the magnitude of duty cycle (D) to ensure that panel 310-1 always (or as much as possible) operates at its MPP

The value of Ptot is expressed by the following formula:

Vtot=[(Vout*Istring)−(Vprimary*Iprimary)]. . . Equation 1

wherein,

Vout is the voltage across output terminals 350(+) and 350(−),

Istring is the string current Is,

Vprimary is the voltage across primary winding 850P, and

Iprimary is the current through primary winding 850P.

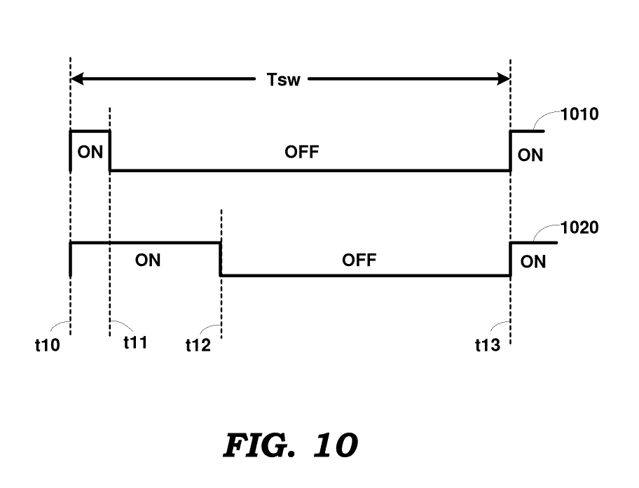

FIG. 10 shows waveforms designed to illustrate the term ‘duty cycle’ used above. In waveform 1010 , the interval t10-t11 represents a duration in which each of switches 860 and 865 is ON (closed), while duration t11-t13 represents a duration in which each of switches 860 and 865 is OFF (open). At t13, switches 860 and 865 are closed again, and the cycle repeats with a frequency of 1/Tsw, Tsw being the duration t10-t13. Similarly, in waveform 1020 the interval t10-t12 represents a duration in which each of switches 860 and 865 is ON (closed), while duration t12-t13 represents a duration in which each of switches 860 and 865 is OFF (open). At t13, switches 860 and 865 are closed again, and the cycle repeats with a frequency of 1/Tsw. Waveform 1020 has a higher duty cycle (D) than waveform 1010.

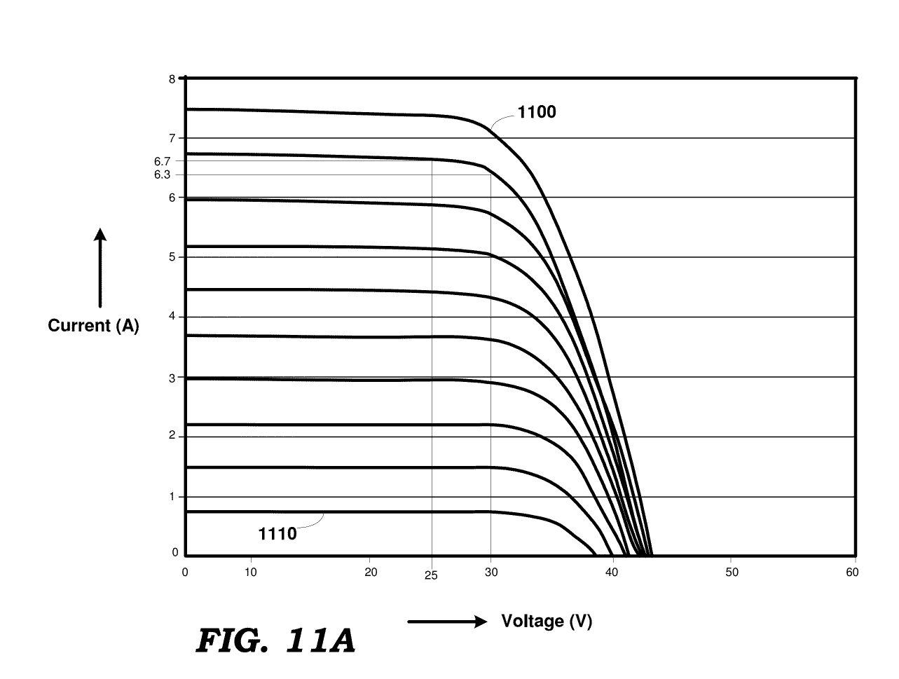

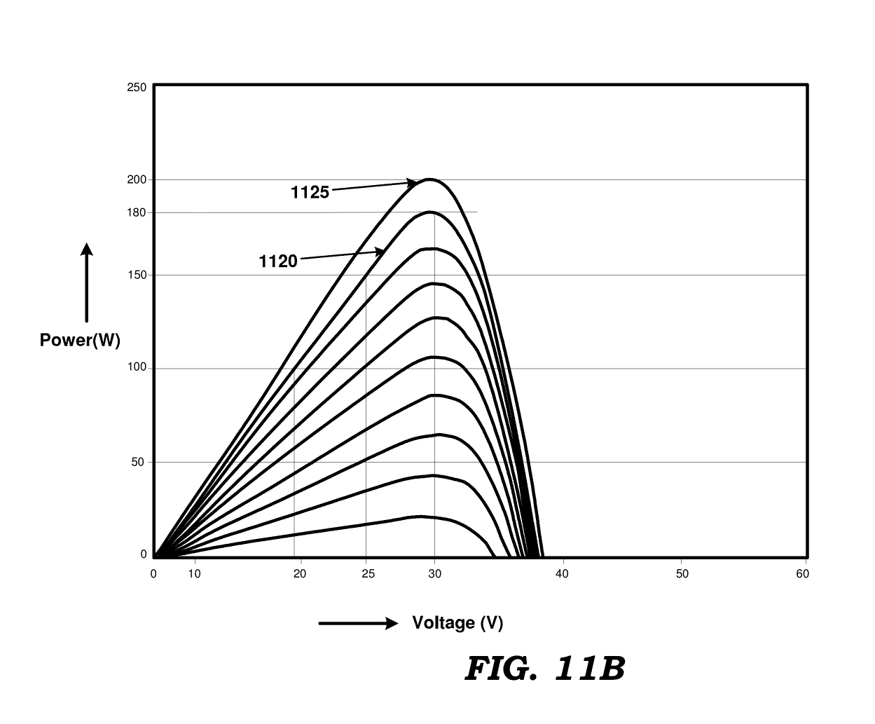

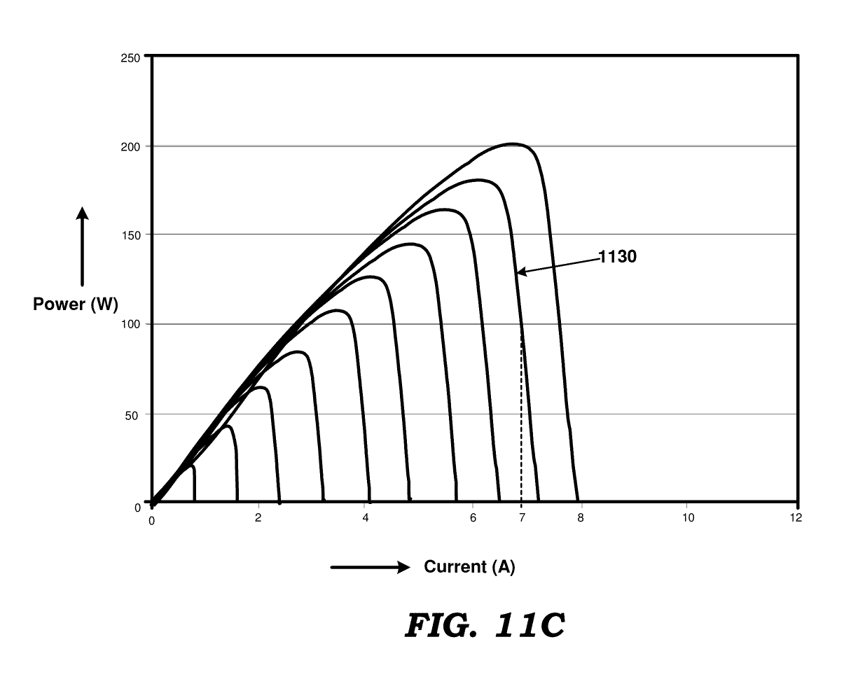

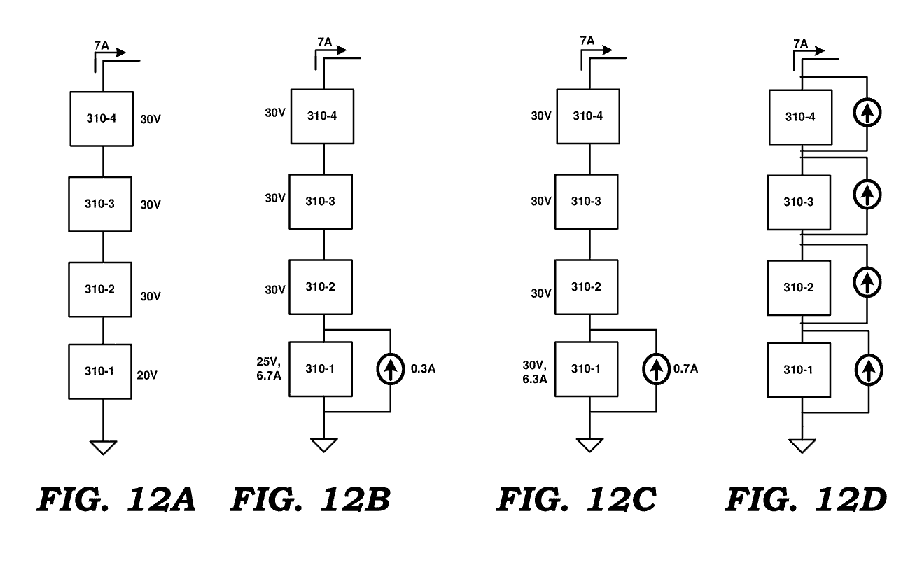

The operation of the flowchart of FIG. 9 is illustrated next with examples, and with reference to FIGS. 11A, 11B, 11C, and FIGS. 12A-12D. The example assumes, merely for illustration, that the number of panels (N) equals four (panels 310-1 through 310-4), and that three of the panels (310-2 through 310-4) are operating at their maximum power point (MPP), while panel 310-1 is shaded, and only 90% illuminated compared to the other three panels. It is also assumed that string current (i.e., string current Is) equals 7 Amperes (A). The set of four panels connected in series is continued to be referred as string 310 below. For conciseness the connections of the panels to optimizer 730 are not shown.

FIG. 11A shows example current-to-voltage relationship for various levels of insolation (incidence of light) of a solar panel. Curve 1100 corresponds to 100% insolation, while curve 1110 corresponds to 10% insolation, with the other curves representing varying levels of insolation between 10% and 100% in steps of 10%. FIG. 11B shows power to voltage variations corresponding to respective curves 1100 through 1110. FIG. 11C shows power to current variations corresponding to respective curves 1100 through 1110. FIG. 11A, 11B and 11C may not be to scale, and serve merely to illustrate.

From FIG. 11B, at 90% insolation, it would be expected that panel 310-1 would deliver 180W (peak of curve 1120). However, current through panel 110-1 is constrained to be 7 A due to series connection of the panels. It may be observed from FIG. 11C that the intersection of the 90% curve (1130) corresponding to 7 A (string current) is only 100 Watts (W). Thus, panel 310-1 delivers only 100 W.

At a power output of 100 W, and from FIG. 11B, the voltage across panel 310-1 is about 20V. FIG. 12A illustrates the state of the four panels. The voltage across each of panels 310-2, 310-3 and 310-4 is 30V (corresponding to the MPP value) as also noted from the peak of curve 1125 in FIG. 11. The voltage across panel 310-1 is 20V. The flyback converter in optimizer 730 is assumed to be non-operative (or duty cycle equals zero) in the scenario of FIG. 12A.

Optimizer 730 measures the output power of string 310 (step 920). Since the ‘present’ reading of output power is greater than the previous initialized value of zero, optimizer 730 increases the duty cycle. At a duty cycle corresponding to generation of 20.7 V in secondary windings of the flyback converter power delivery to panel 310-1 starts, since 20.7 equals the voltage (20V) across panel 310-1 plus one diode drop (0.7V). The diodes corresponding to panels 310-2, 310-3 and 310-4 continue to be reverse biased and no power is transferred to these panels. Ptot equals 770 W (110×7).

In general, for any non zero duty cycle in primary windings 850P, there would be current delivery to panel 310-1 when current in primary winding is switched off. This is due to the fact that 310-1 panel operates at a lower voltage (of 20V corresponding to 90% insolation) compared to the other panels. When some current is added by the secondary winding (850-S1), the panel 310-1 contributes less current than earlier and hence its panel voltage for 310-1 increases from what it was earlier. As long as the panel voltage of 310-1 is less than the other panel voltages no currents flow in the other panels.

Due to the operation of the steps of FIG. 9, the voltage across panel 310-1 continues to rise. FIG. 12B shows the state of the panels when voltage across panel 310-1 reaches 25V. At this setting, and from FIG. 11B, power output of panel 310-1 equals (approximately) 150W. From FIG. 11A, the corresponding current through panel 310-1 equals 6.7 A, with the corresponding programmable current source (740-1) of optimizer 730 supplying 0.3 A (being equal to 7 A minus 6.7 A). Corresponding to this state, Ptot equals 797.5 W ([115×7]−(25×0.3)]. Ptot being greater than the Pprtot (step 925), optimizer 730 increases the value of duty cycle (D), and the voltage across panel 310-1 continues to rise.

Eventually, due to continued increase of duty cycle (D), the voltage across panel 310-1 continues to rise till the voltage reaches 30V, as depicted in FIG. 12C. At a panel voltage of (approximately) 30V, from FIG. 11A, the current through panel 310-1 equals (approximately) 6.3 A, with programmable current source 340-1 supplying the remaining 0.7 A. At approximately 30V, and from FIG. 11B, panel 310-1 supplies the maximum of 180 W possible. The state of FIG. 12C represents a state when each of the panels (310-1 through 310-4) is operating at its MPP.

Any further increase in duty cycle will lead to current getting distributed across all outputs, i.e., programmable current sources 340-2, 340-3 and 340-4 also start operation, as shown in FIG. 12D. However, for the state corresponding to FIG. 12D, the corresponding Ptot would be less than the previous Ptot (i.e., Ptot of the previous iteration), due to increased input power being drawn from terminals 350(+) and 350(−) by optimizer 730. However, due to the finite conversion efficiency of the flyback converter, duty cycle D would be locked at the highest duty cycle such that no current goes into good panels (310-2, 310-3 and 310-4), i.e., corresponding to the state of FIG. 12C. It may be noted from the description above that time spans in which two current sources are provided across corresponding panels overlap only when the outputs of the two panels are equal.

The above example illustrates the scenario when only one panel operates away from its MPP. When multiple panels are operating away from their MPP as well, the steps of the flowchart of FIG. 9, would result in output power being maximized as a whole, rather than for each panel.

It is noted here that although optimizer 730 of FIG. 7 is described as measuring the total output voltage of string 310, in some embodiments, optimizer 730 may individually measure panel voltage and panel current of each panel independently, and determine the voltage across string 310 by summing the individual panel voltages. Subsequently, based on the determined string voltage (voltage across string 310) and string current, optimizer 730 may operate to optimize the power output of string 310, as described above.

Multiple optimizers may be used in conjunction, to optimize larger solar panel arrays. For example, if N equals four, then three of such optimizers can be employed to optimize a serially connected string containing twelve panels. In such deployment scenarios, the corresponding optimizers may include circuitry to enable communication with each other over wired or wireless links.

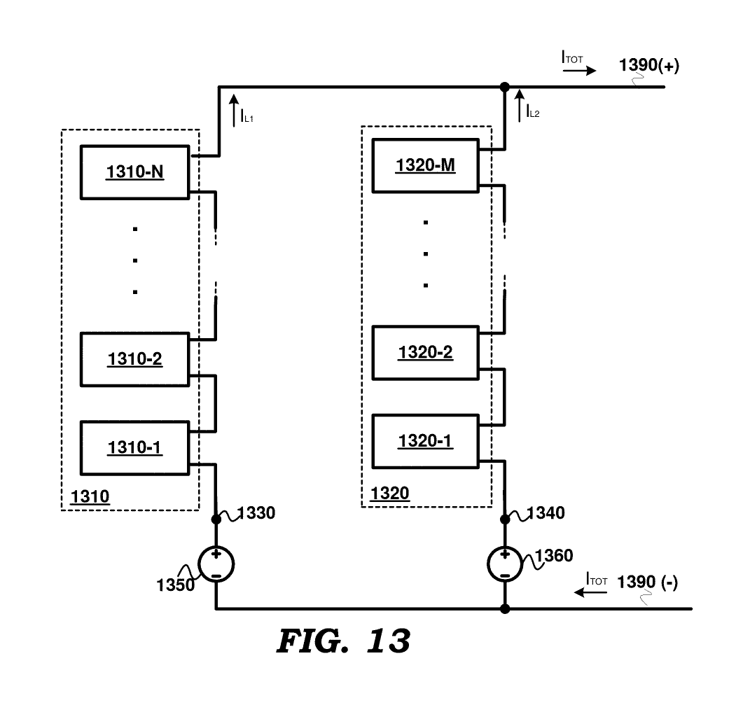

The sharing of a single optimizer can also be performed when it is required to maximize power output of two or more parallely-connected strings of solar panels, as illustrated with respect to FIG. 13. In FIG. 13, panels 1310-1 through 1310-N form one serially-connected string, referred to herein as string 1310. Panels 1320-1 through 1320-M form a second serially-connected string, referred to herein as string 1320. Terminals 1390(+) and 1390(−) may be connected to the inputs of an inverter (not shown), with the output of the inverter being connected to power grid.

String 1310 and string 1320 are connected in parallel to enable a higher current output. Thus, I_{TOT} of FIG. 13 is the sum of Is1 (through string 1310) and Is2 (through string 1310). Terminals 1390 (+) and 1390 (−) represent the output terminals of the solar panel array of FIG. 13. Programmable voltage source 1350 is shown connected in series with string 1310, and programmable voltage source 1360 is shown connected in series with string 1320. The number M of solar panels in string 1320 may be equal to or different from the number N of solar panels in string 1310. If voltage sources 1350 and 1360 were not connected, and instead if nodes 1330 and 1340 were directly connected to node 1390(−), the requirement of both the voltages across string 1310 and string 1320 having to be equal may result in one or more solar panels in string 1310 and 1320 operating at points different from its corresponding MPP. Such operation at points different from the corresponding MPP may result even if M equals N, i.e., even when the number of solar panels in each of string 1310 and string 1320 is equal. As noted above, this may occur due to mismatches between the individual solar panels, different levels of incident light falling on the solar panels, etc.

The connection of voltage sources 1350 and 1360 enables operation of solar panels at their respective MPPs when multiple serially-connected strings are connected in parallel. The magnitude of the voltage output of one or both of voltage sources 1350 and 1360 is set to a value to enable each solar panel of FIG. 4 to operate at its MPP, when strings are paralleled.

To illustrate, assume that the sum of the voltages of panels in string 1310 when each of the panels in string 1310 is operated at its MPP is V1 volts. Assume also that the sum of the voltages of panels in string 1320 when each of the panels in string 1320 is operated at its MPP is V2 volts. Under the above assumptions, paralleling of strings 1310 and 1320 will force at least one of the panels in the strings to deviate from its MPP. Specifically, the voltage output of at least one panel will be different from the voltage corresponding to its MPP, thereby resulting in less-than-maximum power-draw from that panel.

However, when connected as in FIG. 13, and assuming V2 is greater than V1, voltage source 1320 is set to 0V and voltage source 1310 is set to generate (V2-V1) volts, thereby allowing each panel to operate at its MPP. On the other hand, if V1 is greater than V2, voltage source 1310 is set to 0V and voltage source 1320 is set to generate (V2-V1) volts. If V1 equals V2, then each of voltage sources 1310 and 1320 is set to 0 volts.

While FIG. 13 is shown containing only two parallel strings, any number of strings can be formed in parallel, with corresponding voltage sources set to generate voltages to enable the voltage across each parallel string (with each of the constituent solar panels operating at its respective MPPs) to be equal. In addition, although the parallely-connected strings (e.g., string 1310 and string 1320) are described as containing multiple solar panels each, in other embodiments, each of the parallely-connected string may contain only one solar panel. In such embodiments also, a voltage source may be connected in series with each of the parallely-connected solar panels, with the voltage sources operated in a manner similar to that described above.

Similar to the use of a single optimizer to provide multiple programmable current sources as described in detail above, in some embodiments of the present invention a single (shared) optimizer is used to provide both of programmable voltage sources 1350 and 1360. The panels of FIG. 13 may also be connected to corresponding current sources also as described above, but not shown in FIG. 13 in the interest of conciseness. Further, the multiple programmable current sources and programmable voltage sources may all be implemented as a single unit.

While in the description above, a solar panel (e.g., 310-1) is noted as having only a single pair of output terminals, in other embodiments the outputs of sub-sections of a panel may be available as output terminals. Thus, for example, solar panel 310-1 may include ten sub-sections connected in series, with the outputs of each of the sub-sections being available for external control. Just as with a solar panel (e.g., 310-1), each of the sub-sections of a solar panel (e.g., the ten sub-sections of panel 310-1) may also be viewed as a DC source. In such embodiments, the techniques described herein can be used to connect corresponding current sources across each of the sub-sections, to achieve similar benefits. Further, while shown as being powered by output of the solar panel array (terminals 350(+) and 350(−)), optimizers provided according to another aspect of the present invention can also be powered from an intermediate power point, such as for example, node 312-2(+) and 350(−).

Referring again to FIG. 6B, for correct determination of Ipp of a panel in a serially-connected string of panels, the technique described above with respect to FIG. 6A requires that string current (Is) associated with the string be larger than the largest-valued Ipp among the Ipps of panels in the string. When Is is smaller than the Ipps of ‘X’ number of panels in a serial string, then according to the MPP determination algorithm described above, ‘X’ of the corresponding current sources would have a current setting of 0 A, which may be erroneous. The reason for the possible erroneous determination of the required current setting of a current source is that optimizer 330 can only reduce (but cannot add to) the current flowing through the associated panel.

According to an aspect of the present invention, the optimizer providing a voltage-source (referred to conveniently as a ‘voltage source’ optimizer) such as 1350 of FIG. 13 connected in series with a string of panels communicates with a ‘current-source’ optimizers (such as optimizer 330) to obtain information specifying if the ‘current source’ optimizer has determined that the corresponding current source should be set to 0 A. If the current of one or more of the current sources controlled by a ‘current source’ optimizer was determined as 0 A, the ‘voltage source’ optimizer increases the current drawn from terminals 1390(+) and 1390(−) (connections not shown in FIG. 13), thereby increasing the value of Is. After the voltage source optimizer increases its output current (by a predetermined magnitude), the current-source optimizer again determines the MPP and the value of Ipp of the associated panel.

The current-source optimizer communicates to the voltage-source optimizer whether the determined value of the Ipp of the associated panel is 0 A. If any of the re-determined Ipps is 0 A, the voltage source optimizer further increases the value of Is. The determining of the Ipps and increasing of Is is repeated till none of the determined Ipps equals 0 A.

The term ‘voltage source’ as used herein is generally a circuit that generates a constant voltage output despite changes in the value of a current drawn from the voltage source. The term ‘current source’ as used herein is generally a circuit that generates a constant current irrespective of the magnitude of a load into which the current flows.

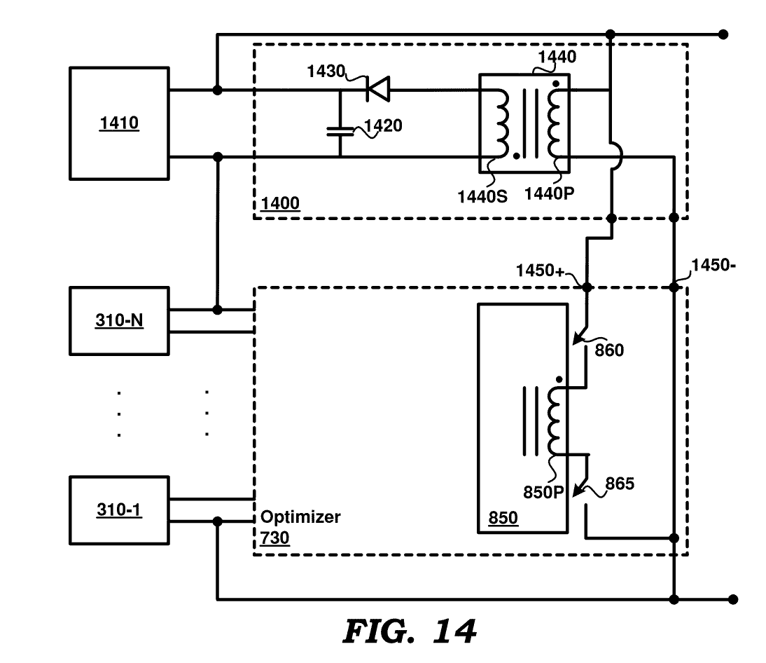

In some deployment environments, solar panels that are to be optimized may be located physically spread apart. In other situations, the number of panels that can be supported (for optimization) by a single optimizer (e.g., 730 of FIG. 8) may be less than a total number of panels for which optimization is desired. In such scenarios, additional (dummy) boxes with corresponding circuitry can be used in conjunction with an optimizer, as illustrated with respect to the example of FIG. 14. An additional panel 1410 is shown there connected in series with string 310 (of FIG. 8). Optimizer 730 (of FIG. 8) is also shown in FIG. 14, switches 860 and 865 representing the similarly numbered transistors of FIG. 8. Box 1400 is shown containing capacitor 1420, diode 1430 and transformer 1440 similar to the circuitry connected to each secondary winding of transformer 850.

Terminals 1450+ and 1450− of optimizer 730 are available for connection to box 1400, and the primary winding 1440P of transformer 1440 is connected in parallel with primary winding 850 of optimizer 730. Box 1400 does not contain any control logic (and hence termed dummy), and the operation of the circuit 1400 is controlled by optimizer 730. The circuit of box 1400 operates identical to any of the circuits connected to the secondary winding of transformer 850 to optimize the series connection of string 310 and panel 1410. The technique can be extended to connect any number of additional dummy boxes similar to 1400, thereby enabling panels to be added and optimized. The technique of FIG. 14 can be applied even when switches are used to optimize each panel in a time-division multiplexed manner, as described with respect to FIG. 4. In such a scenario, the secondary 1440S of transformer 1440 would be connectable via a switch to panel 1410, and each of the corresponding circuits of the secondary windings of transformer 850 would contain a switch to connect to the corresponding panel, as illustrated in FIG. 4.

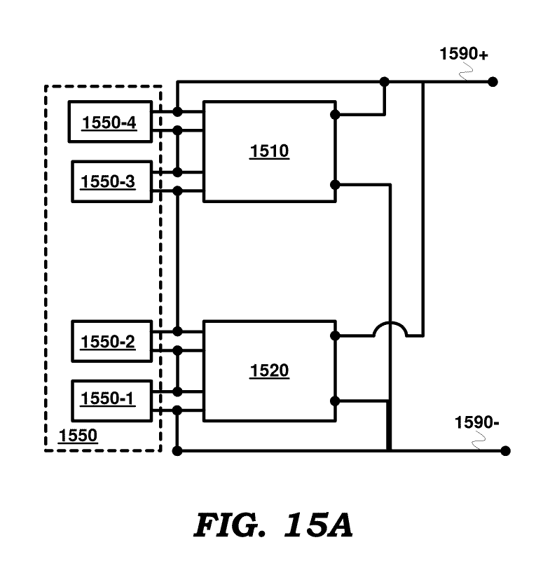

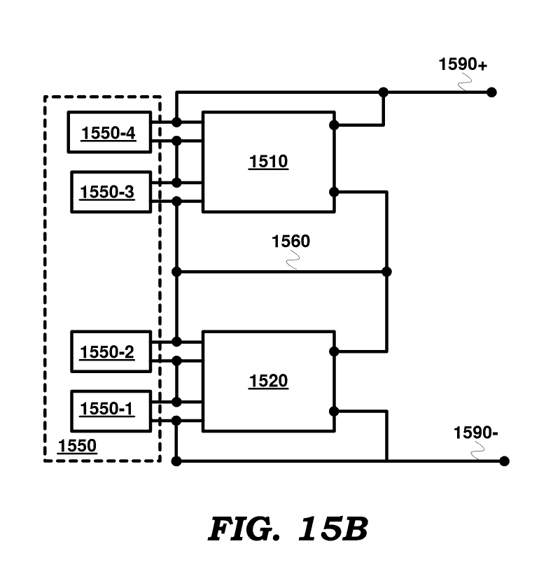

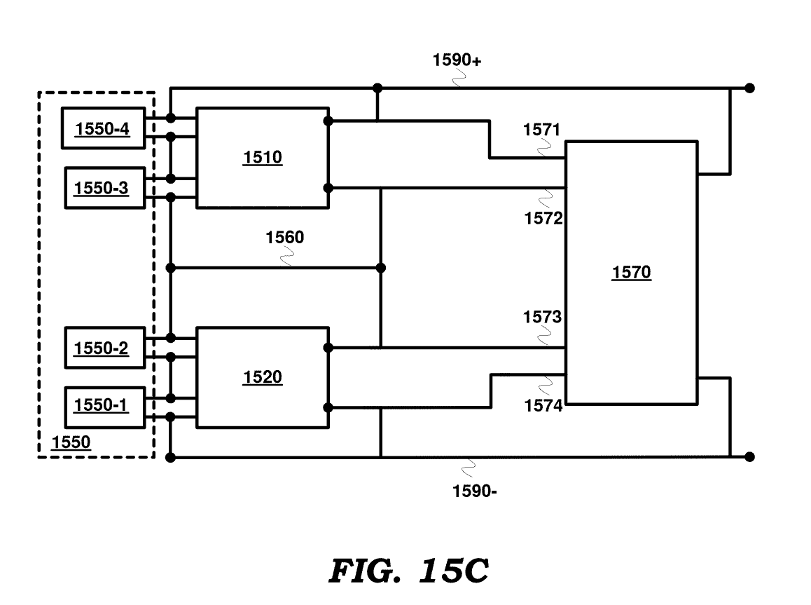

In the description above, an optimizer (e.g., 730) is described as receiving input power (for operation) from the top and bottom of the string of panels. Multiple numbers of such optimizers can be operated using the topology shown in FIG. 15A. In the example of FIG. 15A, panels 1550-1 and 1550-2 are shown connected for optimization by optimizer 1520, panels 1550-3 and 1550-4 being connected for optimization by optimizer 1510. The input power for each of optimizers 1510 and 1520 is drawn from node 1590+ (top of string) and node 1590− (bottom of string). Each of optimizers 1510 and 1520 operate according to the approaches described above to operate the corresponding panels at their respective peak operating points. Additional optimizers may similarly be powered from terminals 1590+ and 1590− to optimize corresponding panels.

Another aspect of the present invention enables operation of multiple optimizers with corresponding input terminals connected to intermediate points in the string of panels, as illustrated with respect to the example of FIG. 15B. In the example of FIG. 15B the same set of panels and optimizers of FIG. 15A are shown. However, in contrast to the arrangement of FIG. 15A, input power for optimizer 1510 is drawn from node 1590+ (top of string) and node 1560 (intermediate point), while the input power for optimizer 1520 is drawn from node 1560 (intermediate point) and node 1590− (bottom of string). Operation of each of panels 1550-1 and 1550-2 at their corresponding peak power points is ensured by optimizer 1520 (which operates according to the approaches described in detail above). Operation of each of panels 1550-3 and 1550-4 at their corresponding peak power points is ensured by optimizer 1510 (which operates according to the approaches described in detail above).

One drawback of the topology of FIG. 15B is that when each of the panels (e.g., 1550-1 and 1550-2) connected to the output of a converter (e.g., 1520) receives less than maximum incident light, the power available to the primary inputs (e.g., nodes 1560 and 1590−) of the corresponding optimizer (e.g., 1520) is also reduced. Under such conditions, the corresponding optimizer (e.g., 1520) may not be able to supply power to form a parallel current source across the corresponding panels (e.g., 1550-1 and 1550-2). Such a drawback can be overcome by adding another optimizer (realized for example as a DC-DC converter) connected as shown in FIG. 15C. Converter 1570 (which may be implemented similar to either of converters 1510 and 1520) receives input power for operation from nodes 1590+ (top of string) and 1590− (bottom of string). Outputs 1571 and 1572 of converter 1570 are connected to the input terminals (1590+ and 1560) of optimizer 1510. Outputs 1573 and 1574 of converter 1570 are connected to the input terminals (1560 and 1590−) of optimizer 1520. Converter 1570 provides additional power for operation of optimizers 1510 and 1520, thereby overcoming the drawback noted above with respect to FIG. 15B.

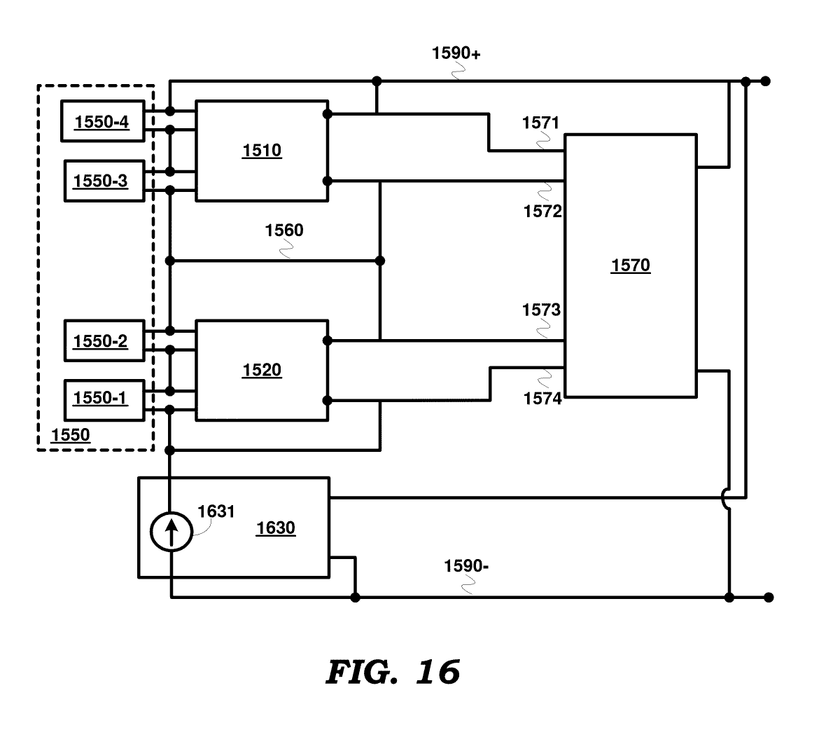

In the arrangement of FIG. 15C, operating point mismatch between panels 1550-1 and 1550-2 can be corrected by optimizer 1520. Similarly, operating point mismatch between panels 1550-3 and 1550-4 can be corrected by optimizer 1510. However, mismatches between panels 1550-1/1550-2 and 1550-3/1550-4 cannot be corrected since neither of the input connections of optimizers 1510 and 1520 is drawn from across the top end (1590+) and bottom end (1590−) of the series string formed by the four panels. In such scenarios, additional circuitry can be used to correct for such mismatch errors, as described with respect to FIG. 16.

In FIG. 16, in addition to the components/blocks of FIG. 15, there is shown circuit block 1630. The inputs of block 1630 are connected to terminals 1590+ and 1590−. The inputs of optimizer 1510 are connected to top end 1590+ and node 1560. The inputs of optimizer 1520 are connected to intermediate point 1560 and node 1574, which is another intermediate point. The connection to and from converter 1570 are identical to those shown in FIG. 15C. The output of block 1630 provides a current source (1631) in series with the string (1550) of panels 1550-1, 1550-2, 1550-3 and 1550-4. Circuit block 1630 operates to maximize the difference of the power across nodes 1590+ and 1590− and the power provided across nodes 1564 and 1590−. When such power is maximized, each panel would operate at its maximum power point. As an example, assume that the maximum power point of each of panels 1550-1 and 1550-2 corresponds to 5 Volts (V), 2.5 Amperes (A). Assume also that the maximum power point of each of panels 1550-3 and 1550-4 is 5V, 2A. Circuit block 1630 may initially force current 1631 to be 2A, and the voltage across nodes 1564 and 1590− to be 5V. Then, circuit block 1630 measures the difference of output power (across 1590+ and 1590−), and the power delivered (5V×2 A). Circuit block 1630 may then increase current 1631, and again measure the difference of output power and delivered power. Circuit block 1630 repeats the above operations till the difference of the output power and the power delivered is determined to be a maximum. When the difference is a maximum, panels 1550-1 through 1550-4 would be operating at their respective maximum power points. It is noted that although circuit block 1630 (which may be implemented as a DC-DC converter) is described as providing a current source (1631), in other embodiments, circuit block 1630 may instead provide a voltage source with corresponding changes to the manner in which operation at maximum power points is effected.

In the illustrations of the relevant Figures, although terminals/nodes are shown with direct connections to various other terminals, it should be appreciated that additional components (as suited for the specific environment) may also be present in the path, and accordingly the connections may be viewed as being electrically coupled to the same connected terminals.

While various embodiments of the present disclosure have been described above, it should be understood that they have been presented by way of example only, and not limitation. Thus, the breadth and scope of the present disclosure should not be limited by any of the above-described embodiments, but should be defined only in accordance with the following claims and their equivalents.

What is claimed is:

1. A system for generating electric power, said system comprising:
a first DC source to provide a first voltage across a first node and a second node,
a second DC source to provide a second voltage across said second node and a third node; and
a shared optimizer to provide a first programmable current source between said first node and said second node as well as a second programmable current source between said second node and said third node.

2. The system of claim 1, wherein each of said first DC source and said second DC source is implemented in the form of a corresponding set of photo-voltaic cells such that said first DC source comprises a first set of photo-voltaic cells and said second DC source comprises a second set of photo-voltaic cells,
wherein said first set of photo-voltaic cells are provided in a first panel and said second set of photo-voltaic cells are provided in a second panel,
wherein said first panel and said second panel are connected in series at said second node between said first node and said third node.

3. The system of claim 2, further comprising:
a first switch and a second switch,
wherein said shared optimizer is coupled to said first DC source through said first switch, wherein said shared optimizer is coupled to said second DC source through said second switch,
wherein said first programmable current source is operative to generate current only in a first set of time intervals, while said second programmable current source is operative to generate current only in a second set of time intervals,
wherein each interval of said first set of time intervals is non-overlapping with at least a respective portion of a corresponding interval of said second set of time intervals.

4. The system of claim 3, wherein each interval of said first set of time intervals is non-overlapping with each of a corresponding interval of said second set of time intervals, wherein said shared optimizer comprises a DC-DC converter containing said first programmable current source and said second programmable current source.

5. The system of claim 4, wherein said DC-DC converter is implemented as a flyback converter, said shared optimizer further comprising a processor to determine a magnitude of the respective currents to be generated by each of said first programmable current source and said second programmable current source.

6. The system of claim 5, wherein said flyback converter further comprises a transformer, said transformer containing a primary winding and a plurality of secondary windings,
each of said secondary windings being comprised in a corresponding programmable current source such that a first secondary winding and a second secondary winding are respectively comprised in said first programmable current source and said second programmable current source, wherein said first secondary winding is coupled to said first DC source through said first switch, and said second secondary winding is coupled to said second DC source through said second switch,
said processor to measure a power generated by each of said first panel and said second panel for each of a set of corresponding duty cycles of an ON-duration for which current is permitted to flow through said primary winding,
said processor to drive said primary winding with a first duty cycle in each of said first set of time intervals at which the value of power generated by said first panel is maximum,
said processor to drive said primary winding with a second duty cycle in each of said second set of time intervals at which the value of power generated by said second panel is maximum.

7. The system of claim 6, wherein said flyback converter further comprises:
a capacitor and a diode combination for each of said secondary windings,
said capacitor being coupled across the two output nodes of the corresponding panel,
wherein said diode is connected in between a first terminal of said capacitor and a terminal of said secondary winding.

8. The system of claim 2, wherein said shared optimizer is directly connected to each of said first DC source and second DC source.

9. The system of claim 8, wherein said shared optimizer comprises a DC-DC converter containing said first programmable current source and said second programmable current source.

10. The system of claim 9, wherein said DC-DC converter is implemented as a flyback converter, said shared optimizer further comprising a processor to determine a magnitude of the respective currents to be generated by each of said first programmable current source and said second programmable current source.

11. The system of claim 10, wherein said flyback converter further comprises a transformer, said transformer containing a primary winding and a plurality of secondary windings,
each of said secondary windings being comprised in a corresponding programmable current source such that a first secondary winding and a second secondary winding are respectively comprised in said first programmable current source and said second programmable current source,
said processor to measure a net power generated by the series connection of said first panel and said second panel for each of a set of duty cycles of an ON-duration for which current is permitted to flow through said primary winding, wherein said net power represents a difference between power generated by said series connection of said first panel and said second panel, and the power fed to said series by said optimizer,
said processor to drive said primary winding with a duty cycle at which the value of said net power is maximum.

12. The system of claim 11, wherein said flyback converter further comprises:
a capacitor and a diode combination for each of said secondary windings,
said capacitor being coupled across the two output nodes of the corresponding panel,
wherein said diode is connected in between a first terminal of said capacitor and a terminal of said secondary winding.

13. The system of claim 1, further comprising:
a third DC source to provide a third voltage across a fourth node and a fifth node;
a fourth DC source to provide a fourth voltage across said fifth node and said third node;
a first programmable voltage source coupled in series with said first DC source and said second DC source;
a second programmable voltage source coupled in series with said third DC source and said fourth DC source,
wherein the series combination of said first programmable voltage source, said first DC source and said second DC source is coupled in parallel with the series combination of said second programmable voltage source, said third DC source and said fourth DC source between said first node and said third node,
wherein each of said first programmable voltage source and said second programmable voltage source is also provided by said shared optimizer.

14. The system of claim 6, wherein said first duty cycle is the same as said second duty cycle, wherein each of said first set of time intervals is the same as each of said second set of time intervals, wherein each of said first switch and said second switch is operable to be closed for a corresponding duration in each of said first set of time intervals.

15. The system of claim 7, wherein input terminals of said primary winding are available as external terminals of said optimizer, said system further comprising:
a third panel coupled in series with said first panel and said second panel; and
a dummy box comprising a second transformer, wherein primary windings of said second transformer are connected in parallel to said primary winding via said external terminals, wherein a secondary winding of said second transformer is coupled to output terminals of said third panel via a second diode and a second capacitor,
whereby operation of said optimizer causes each of said first panel, said second panel and said third panel to operate at respective maximum power points.

16. The system of claim 1, further comprising:
a third DC source to provide a third voltage across said third node and a fourth node,
a fourth DC source to provide a fourth voltage across said fourth node and a fifth node; and
a second shared optimizer to provide a third programmable current source between said third node and fourth second node as well as a fourth programmable current source between said third node and said fourth node,

17. The system of claim 16, wherein a first input terminal and a second input terminal of said shared optimizer are coupled respectively to said first node and said fifth node,
wherein a first input terminal and a second input terminal of said second shared optimizer are also coupled respectively to said first node and said fifth node.

18. The system of claim 16, wherein a first input terminal and a second input terminal of said shared optimizer are coupled respectively to said first node and said third node,
wherein a first input terminal and a second input terminal of said second shared optimizer are coupled respectively to said third node and said fifth node.

19. The system of claim 18, further comprising:
a circuit block to provide one of a current source and a voltage source in series with outputs of said first DC source, said second DC source, said third DC source and said fourth DC source, p1 wherein a first input terminal and a second input terminal of said circuit block are coupled respectively to said first node and said fifth node,
wherein said circuit block adjusts said one of said current source and said voltage source to a magnitude to enable operation of each of said first panel, said second panel, said third panel and said fourth panel at their respective maximum power points.

20. A method of generating electric power using a first DC source and a second DC source, said first DC source providing a first voltage across a first node and a second node, said second DC source providing a second voltage across said second node and a third node, said method comprising:
providing, using a shared optimizer, a first programmable current source between said first node and said second node, and a second programmable current source between said second node and said third node,
wherein said first programmable current source is provided in a first set of intervals and said second programmable current source is provided in a second set of intervals,
wherein intervals in the first set of intervals in which said first programmable current source is provided do not overlap with intervals in said second sequence of intervals in which said second programmable current source is provided, during at least some time intervals.

21. The method of claim 20, wherein said first set of intervals comprises a first sequence of non-contiguous durations and said second set of intervals comprises a second sequence of non- contiguous durations,
wherein the first sequence of non-contiguous durations are completely non-overlapping with said second sequence of non-contiguous durations.

22. The method of claim 21, wherein said shared optimizer is coupled to each of said first DC source and second DC source via corresponding switches.

23. The method of claim 22, wherein said shared optimizer is implemented as a DC-DC converter.

24. The method of claim 20, wherein said first set of intervals occurs in a first time span and said second set of intervals occurs in a second time span.

25. The method of claim 24, wherein said shared optimizer is directly connected to each of said first DC source and second DC source.

26. The method of claim 25, wherein said shared optimizer is implemented as a DC-DC converter.
